(19) United States
(12) Patent Application Publication
(10) Pub. No.: US 2004/0190506 A1
(43) Pub. Date: Sep. 30, 2004

(54) Method and apparatus for performing complex pattern matching in a data stream within a computer network

(75) Inventors: Gordon Taylor Davis, Chapel Hill, NC (US); Charles Steven Lingafelt, Durham, NC (US); Norman Clark Strole, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corp., Armonk, NY

(21) Appl. No.: 10/395,722

(22) Filed: Mar. 24, 2003

(51) Int. Cl. H04L 12/28

(52) U.S. Cl. 370/389

(57) ABSTRACT

An apparatus for performing complex pattern matching in a data stream within a computer network is disclosed. The apparatus includes a serial array register and a content-addressable memory (CAM). The CAM includes multiple CAM entries, and each of the CAM entries includes a k-byte pattern concatenated with an n-byte mask. The positions of the k-byte pattern and n-byte mask in each of the CAM entries offset from those in other CAM entries by one byte. Preferably, the k-byte pattern is each of the CAM entries represents a known computer virus pattern. After the capture of a data pattern from a data stream by the serial array register, the CAM register performs a comparison operation between the captured data pattern and all the CAM entries. If there is a match between the captured data pattern and one of the CAM entries, the CAM signals that the data stream contains information that are potentially harmful to the computer network.

### BACKGROUND OF THE INVENTION

1. Technical Field

The present invention relates to network processing in general, and in particular, to a method and apparatus for processing packets within a computer network. Still more particularly, the present invention relates to a method and apparatus for performing complex pattern matching in a data stream within a computer system and/or a computer network.

2. Description of the Related Art

In a packet-switch computer network, a router is a device that moves data packets from a source device to a destination device. Each data packet typically includes header information that indicates a destination device (and other information), and a router contains routing information that associates an output interface with information regarding the destination device. A router can also perform other operations on data packets, such as re-routing packets according to a routing protocol or to re-encapsulate data packets from a first routing protocol to a second routing protocol. Needless to say, it is advantageous for a router to operate as quickly as possible, so that as many data packets can be switched at any given time as possible.

Generally speaking, a router has a network processor to expedite packet classification and address lookup operations for data packets with well-known and predefined formats. Special tree-search operations or content-addressable memory-based lookup schemes are commonly used to perform such tasks. It is certainly advantageous to have a predefined format when constructing lookup keys as a collection of subfields from various parts of a data packet. However, data packets having an unknown start location within an information field cannot be readily handled by existing data packet processing schemes. Besides, some of those data packets having an undefined data pattern may be associated with malicious software viruses for disrupting normal operations of a computer or network device. Consequently, it would be desirable to provide a method and apparatus for rapidly performing complex pattern matching in a data stream within a computer network in order to identify all data packets that are potentially harmful to the computer network.

### SUMMARY OF THE INVENTION

In accordance with a preferred embodiment of the present invention, an apparatus for performing complex pattern matching in a data stream within a computer network includes a serial array register and a content-addressable memory (CAM). The serial array register receives data streams from the computer network. The CAM includes multiple CAM entries, and each of the CAM entries includes a k-byte pattern concatenated with an n-byte mask. The positions of the k-byte pattern and n-byte mask in each of the CAM entries offset from those in other CAM entries by one or more bytes. Preferably, the k-byte pattern in each of the CAM entries represents a known computer virus pattern. After the capture of a data pattern from a data stream by the serial array register, the CAM register performs a comparison operation between the captured data pattern within the serial array register and all the CAM entries within the CAM. If there is a match between the captured data pattern within the serial array register and one of the CAM entries within the CAM, the CAM signals that the data stream contains information -that are potentially harmful to the computer network.

As an alternative embodiment, all the CAM entries are divided into multiple groups, and the CAM entries within each group includes a variable width pattern concatenated with a variable width mask. The positions of the variable width pattern and the variable width mask in each of the CAM entries within each group offset from the other CAM entries within the same group by one or more bytes. The total width of the variable width pattern and the variable width mask are identical within each of the groups.

All objects, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a computer network in which a preferred embodiment of the present invention is incorporated;

FIG. 2 is a block diagram of an apparatus for scanning data streams within a computer network, in accordance with a preferred embodiment of the present invention; and

FIG. 3 is a pictorial depiction of the data patterns within the content-addressable memory from FIG. 2, in accordance with a preferred embodiment of the present invention.

### DETAILED DESCRIPTION OF A PREFERRED EMBODIMENT

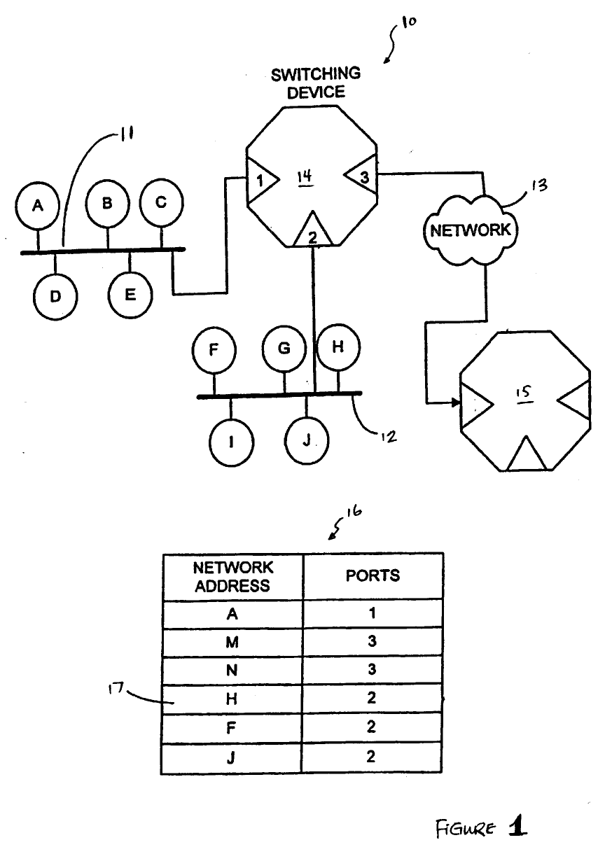

Referring now to the drawings and in particular to FIG. 1, there is depicted a block diagram of a computer network in which a preferred embodiment of the present invention is incorporated. As shown, a computer network 10 includes two local segments 11-12, and a connection to a remote computer network 13. Computers connected to local segments 11 and 12 are represented by nodes A-J. A switching device 14, which includes three ports 1-3, switches network traffic between segments 11-12 and remote computer network 13. Remote computer network 13 may also include switching devices, such as a switching device 15, which may connect other segments (not shown) to remote computer network 13. Switching device 14 allows nodes on one segment to communicate with nodes on other segments and to other switching devices. Nodes can communicate with each other through well-known network communication protocols, such as HTTP, TCP/IP, SMB, etc., which allows the nodes to transmit and receive data packets.

A data packet typically includes a destination address field, a source address field and a data field. When switching device 14 receives a data packet from a node, it analyzes the destination address of the data packet by searching through a lookup table, such as a lookup table 16. Lookup table 16 includes table entries having a network address field and a port field. When the destination address is matched to a network address in lookup table 16, switching device 14 determines which port to forward the data packet to by obtaining a port number corresponding to the matched network address. For example, if node A on segment 11 sends a data packet to node H on segment 12, switching device 14 receives the data packet from node A and, in response, searches the entries in the network address field of lookup table 16. Since table entry 17 contains the network address for H, a corresponding port field for network address H indicates that the data packet should be forwarded to port 2.

Switching device 14 can obtain network addresses for lookup table 16 in different ways, depending on the particular implementation of switching device 14. For example, switching device 14 may snoop network traffic so that when a data packet is received on a port, switching device 14 then determines if the data packet's source address is in lookup table 16 and, if it is not, adds an entry containing the source address and the inbound port to lookup table 16. Thus, switching device 14 is capable of “learning” source addresses and port numbers from any data packet that is transmitted by a node. Another technique some switching devices, such as routers, may use is to obtain lookup tables from other switching devices through a special protocol in order to supplement their own lookup table.

Basically, after a data packet has been received by a switching device, such as switching device 14, both the source and destination addresses of the data packet must be searched in a lookup table, such as lookup table 16—the source address for “learning” and the destination address for forwarding. In order to perform a search within the lookup table, a single search engine within the switching device sequentially accesses entries within the lookup table and compares the entries to the destination address of the data packet. After the search for the destination address has been completed, a second independent search is performed for the source address.

A network processor is normally used for high-speed data packet handling and manipulation within a switching device. Selected fields within each data packet, such as a header field or data field, are used for classifying data packets as they are being received. The present invention augments the flexibility of a network processor to examine the entire contents of a data stream in an effort to detect complex data patterns that are known to represent computer viruses or potential computer network attacks.

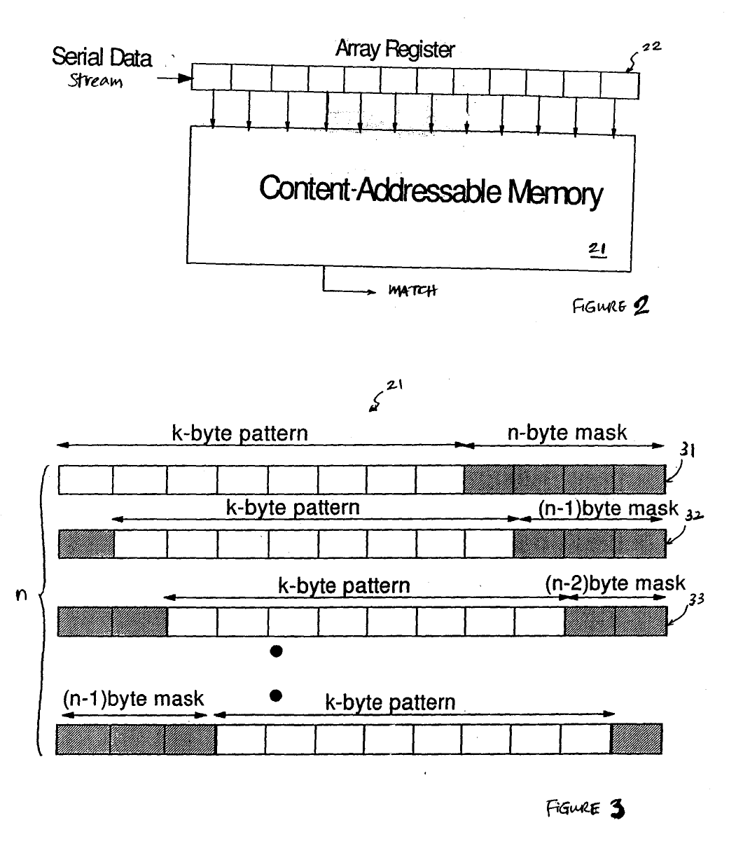

With reference now to FIG. 2, there is depicted a block diagram of an apparatus for scanning data streams within a computer network, in accordance with a preferred embodiment of the present invention. As shown, the apparatus for scanning data streams within a computer network includes a content-addressable memory (CAM) 21 coupled to a sequential array register 22. The widths of CAM 21 and array register 22 are determined by the maximum length of a data packet in k bytes that must be examined to form a positive match to locate sequences of interest, and an additional number of n bytes to serve as a mask for the data packet. As such, the total width of CAM 21 and array register 22 is k+n bytes, where n relates to the rate at which CAM 21 must be read as will be further described.

Referring now to FIG. 3, there is a pictorial depiction of various data patterns within CAM 21, in accordance with a preferred embodiment of the present invention. As shown, CAM 21 has a total of n CAM entries for each k-byte pattern. Each of the n CAM entries includes a k-byte pattern and an n-byte mask. The first CAM entry 31 includes a k-byte pattern with a single n-byte mask to the right of the pattern. Each subsequent CAM entry rotates the previous entry by one byte position, repositing the rightmost byte from the previous entry as the leftmost byte for the subsequent entry. For example, CAM entry 31 includes a k-byte pattern concatenate with a n-byte mask; CAM entry 32 includes a k-byte pattern concatenate with a (n−1)-byte mask, with one of the n bytes wrapped around the k-byte pattern; CAM entry 33 includes a k-byte pattern concatenate with a (n−2)-byte mask, with two of the n bytes wrapped around the k-byte pattern.

The k-byte pattern in each CAM entry is preferably a predetermined pattern based upon a priori knowledge of virus signatures, known indicators of computer network attacks, etc. As such, CAM 21 includes a list of well-known k-byte computer virus patterns (or sequences) that are determined to be harmful to the computer network.

During operation, a serial data stream from a computer network is sent to array register 22. A comparison operation is then simultaneously performed between the data pattern within array register 22 and all the n CAM entries within CAM 21. After the comparison operation, the serial data stream is shifted n+1 bytes and a new comparison operation is again performed between the new data pattern within array register 22 and all the n CAM entries for all k-byte patterns within CAM 21. Basically, the serial data stream in array register 22 is shifted n+1 bytes for each successive comparison operation. This guarantees that the full-length of the k-byte pattern to be captured in k+n array register 22 at least once. If there is a match between the data pattern within array register 22 and one of the CAM entries within CAM 22, CAM 22 signals that the data stream contains information that are potentially harmful to the computer network.

A CAM access cycle time of 8 nanoseconds allows a maximum of 125 million accesses per second to be achieved. Assuming that data is clocked into array register 22 at 32 bit (4-byte) increments per access, an aggregate input rate of 32×125 or 4 gigabits/second can be sustained. If there are three CAM entries per pattern, a 128K entry CAM can support 42,000 patterns. A possible total CAM width ranges from 64 bits up to 256 bits, including the extra 32 bits.

As mentioned previously, one application of the present invention is to examine input strings of a data stream to search for one or more k-byte computer virus sequences. This, of course, assumes that the valid signature of multiple computer viruses are all of the same length k. Another application of the present invention is to search for multiple strings simultaneously that do not have the same length. In such application, k represents the maximum length string in CAM 21 and n represents the minimum length mask size. Thus, the width of CAM 21 is k+n bytes and n is the number of replicated entries (with masks) for the maximum length string. Search strings of length less than k, for example k−x, require that a longer mask, n+x, be applied. Also, strings of length k−x are replicated n+x times in CAM 21. Assuming that there is a minimum length string of interest, for example kₘᵢₙ, then x may be any value from 0 to (k−kₘᵢₙ).

When multiple length strings are included, the number of bytes shifted between comparison operations is determined by the minimum mask length n. This also determines the maximum comparison rate that can be achieved. A shift of n+1 bytes assures that every string of interest will be captured at least once within k+n array register 22.

As has been described, the present invention provides an improved method and apparatus for performing complex pattern matching in a data stream within a computer network. The present invention can increase the performance of a CAM-based searching device when used to search for hundreds or thousands of data patterns within data streams of variable lengths. The speed increase is gained by a small increase in the width of the CAM and replication of the patterns within the CAM with a well-defined masking scheme. The increase in data rate is in direct proportion to the additional width of the CAM, assuming byte-aligned comparison operations. The cost of increasing the CAM width and replicating the search patterns is much lower than providing additional CAM modules to increase the access bandwidth for single-entry compare operations.

Although the present disclosure describes a CAM having width k+n, where k is the maximum length of the search string and n is the width of the mask, for examining a variable length data stream for anticipated data patterns of unknown start position within the data stream, multiple strings of different length, k−x bytes, with different mask widths, n+x, are also allowed, with the minimum length string, kₘᵢₙ, determining the maximum value of x=k−kₘᵢₙ. With the present invention, simultaneously searching for multiple strings of different lengths is allowed such that n+x copies of k−x byte strings are included within the CAM, with the longest string k and the shortest length mask n determining the CAM width k+n and the maximum byte shift between compares, n+1.

While the invention has been particularly shown and described with reference to a preferred embodiment, it will be understood by those skilled in the art that various changes in form and detail may be made therein without departing from the spirit and scope of the invention.

What is claimed is:

1. An apparatus for performing complex pattern matching in a data stream within a computer network, said apparatus comprising:
a serial array register for receiving a data stream; and
a content-addressable memory (CAM), coupled to said serial array register, for performing comparison operations between a data pattern within said serial array register and a plurality of CAM entries within said CAM, wherein said plurality of CAM entries includes a k-byte pattern of concatenated with an n-byte mask, wherein the positions of said k-byte pattern and n-byte mask in each of said plurality of CAM entries offset from other CAM entries by an offset.

2. The apparatus of claim 1, wherein said apparatus further includes means for shifting data stream in said serial array register n+1 bytes after each comparison operation.

3. The apparatus of claim 1, wherein said apparatus further includes means for signaling said data stream contains information that are potentially harmful to said computer network when there is a match between said data pattern within said serial array register and one of said CAM entries within said CAM.

4. An apparatus for performing complex pattern matching in a data stream within a computer network, said apparatus comprising:
a serial array register for receiving a data stream; and
a content-addressable memory (CAM), coupled to said serial array register, for performing comparison operations between a data pattern within said serial array register and a plurality of CAM entries within said CAM, wherein said plurality of CAM entries are divided into multiple groups, each group includes a pattern of variable width concatenated with a mask of variable width, wherein the positions of said variable width pattern and said variable width mask in each CAM entries within each of said groups offset from other CAM entries within said each of said groups by an offset, wherein the total width of said variable width pattern and said variable width mask are identical within each of said groups.

5. The apparatus of claim 4, wherein said apparatus further includes means for shifting data stream in said serial array register by said offset after each comparison operation.

6. The apparatus of claim 4, wherein said apparatus further includes means for signaling said data stream contains information that are potentially harmful to said computer network when there is a match between said data pattern within said serial array register and one of said CAM entries within said CAM.

7. A method for performing complex pattern matching in a data stream within a computer network, said method comprising:
receiving a data stream by a serial array register; and
performing comparison operations between a data pattern within said received data stream and a plurality of content-addressable memory (CAM) entries within a CAM, wherein said plurality of CAM entries includes a k-byte pattern concatenated with an n-byte mask, wherein the positions of said k-byte pattern and n-byte mask in each of said plurality of CAM entries offset from other CAM entries by an offset.

8. The method of claim 7, wherein said method further includes shifting data stream in said serial array register n+1 bytes after each comparison operation.

9. The method of claim 7, wherein said method further includes signaling said data stream contains information that are potentially harmful to said computer network when there is a match between said data pattern within said data stream and one of said CAM entries within said CAM.
